(19) United States
(12) Patent Application Publication
(10) Pub. No.: US 2002/0032580 A1
(43) Pub. Date: Mar. 14, 2002

(54) Method of directing patients to medical care

(76) Inventor: John W. Hopkins, Bloomfield Hills, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 09/844,091

(22) Filed: Apr. 27, 2001

Related U.S. Application Data
(60) Provisional application No. 60/200,049, filed on Apr. 27, 2000.

(51) Int. Cl. G06F 17/60

(52) U.S. Cl. 705/2

(57) ABSTRACT

A business method is disclosed wherein a company promotes health awareness, education and access to a healthcare system. The company advertises its services to reach prospective patients with a specified medical condition and has patient advocate personnel to answer inquiries. The company arranges with doctors and medical suppliers who specialize in the specified medical condition and with other entities to become contributors for funding of a healthcare pathway. A patient advocate shepherds assigned patients through the healthcare pathway at no cost to the patient. The company arranges with not-for-profit associations to provide affinity grant funding in return for supplying prospective patients. The healthcare pathway provides the patients with expedited treatment and enables doctors and suppliers specializing in the specific medical condition to be more efficient and enables the company to be financially self-sustaining.

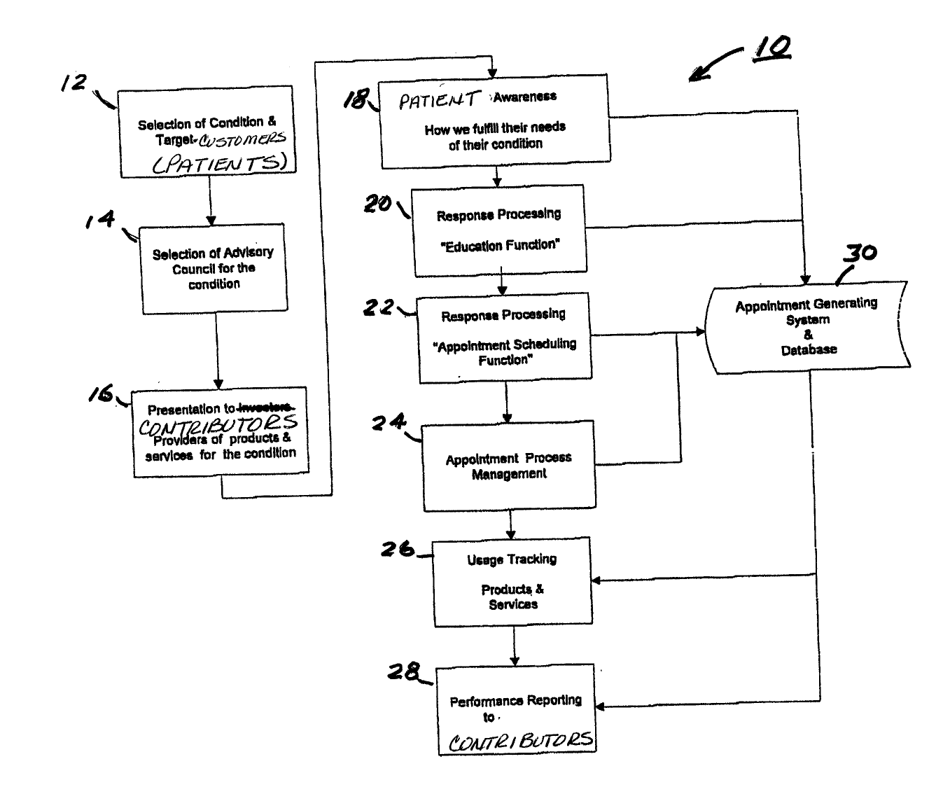

### FIELD OF THE INVENTION

This invention relates to a method of doing business; more particularly it relates to a method for use in the health care industry to facilitate the flow of patients through the early stage of need to the sources of care and treatment of their condition.

### BACKGROUND OF THE INVENTION

There is a critical need in the health care industry for an improved process in which a person needing professional care is shepherded through the various steps needed for ultimately reaching the professional treatment required for the persons particular condition. Presently, there is much time and effort wasted in bringing a potential patient together with the right doctor and medical facilities for proper treatment. The present system is highly inefficient in respect to expenditure of the time of health care professionals in procuring patients and also in the loss of time experienced by a patient in finding the right doctor. Also, there is currently an inefficient process of advertising and promotion of available medications and prosthetics which are needed by specialists in the medical field for treatment of specific conditions.

Also there is a need for moving the stream of patients faster and more expeditiously from their state of need to the health care experts who can give them specialized treatment needed for their condition. Further, there is a need for providing greater financial incentive to the doctors to function in a system that permits them to use their time to do what they are best qualified to do and to avoid using their time for acquiring and following up on treatment of patients.

It is a principal object of this invention to overcome certain difficulties and inefficiencies in the health care industry.

### SUMMARY OF THE INVENTION

In accordance with this invention, an organization of skilled persons, data processing systems, communications programs and communications facilities, herein referred to as “a facilitator” is provided as an intermediary among the various components of the health care industry and prospective patients. This is set forth in the description that follows taken with the accompanying drawing.

### DESCRIPTION OF THE DRAWING

The single drawing FIGURE is a flow chart of the methodology of this invention.

### BEST MODE FOR CARRYING OUT THE INVENTION

An illustrative embodiment of the invention will now be described with reference to a method of doing business which is practiced by a company in the health care industry to facilitate the flow of patients through the early stage of need to the sources of care and treatment of their specific medical condition. However, it will be appreciated as the description proceeds that the invention may be used in other applications and may be implemented in other embodiments.

The Facilitator Company

The invention resides in a method of doing business which is performed by a business entity herein referred to as the facilitator company. The facilitator company is preferably a not-for-profit company and has business purposes of generating health care awareness, providing health care education and providing a health care access system. The facilitator company has management and other personnel as needed for carrying out its business purpose including patient advocates for prospective patients. The patient advocates are trained medical personnel such as nurses. The facilitator company also has communications facilities including a telephone system and a computer system with access to the internet and has a website on the internet that allows them to communicate with patients, doctors, health systems, managed care insurance companies and pharmacy companies. The facilitator company establishes and operates a “wellness pathway” which is available to the public in a worldwide health care system. The wellness pathway is a system for moving a stream of patients from their state of need to the health care experts who can give them specialized treatment needed for their specific medical condition.

The facilitator company is, for example, named “TeleCareCenter^{SM}” (hereinafter referred to as TCC). In the description that follows, the facilitator company will be referred by the name TCC in most instances.

TCC may provide a dedicated and distinct wellness pathway for each of several different specific medical conditions such as erectile dysfunction, diabetes and others. For clarity and convenience of description, the wellness pathway for erectile dysfunction (herein referred to as “ED”) will be used as an example specific medical condition.

Contributors to Funding of TCC

TCC has arrangements for providing cooperative funding from certain entities, sometimes referred to herein as contributors. Payments and fees from such sources support costs of operation of TCC including the costs of awareness advertising, education programs and costs of providing access of prospective patients to the wellness path. Cooperative funding, for example, comes from doctors, suppliers, health insurance companies, health systems, pharmacies and government as discussed below.

TCC has an arrangement with a number of different doctors who specialize in ED so that their expertise may be made available to prospective patients in the wellness path of TCC. Each of the doctors has an agreement with TCC which, in general, provides that the doctor will accept a specified prospective patient for at least one appointment which will be made and coordinated by a patient advocate from TCC. Also, the doctor agrees to pay a fee to TCC. An example of a typical agreement between a doctor and TCC is attached as Exhibit A.

TCC also has arrangements with suppliers including but not limited to manufacturers and distributors of medical drugs and medical devices. Each such supplier is a subscriber to the TCC wellness pathway and has one or more products which is useful for treating ED. Preferably, TCC has more than one supplier specializing in the same medical condition. Each supplier is under agreement with TCC which, in general, provides that it will make its products available to doctors who are subscribers to the TCC wellness pathway. Further, each of the suppliers agree to report the name of each doctor who has used its products and other specified information which is indicative of the extent of the doctor's involvement is useful to TCC for identifying doctors who specialize in ED. Additionally, the supplier agrees to pay a fee to the TCC for using the pathway, e.g. a certain fee per patient appointment.

Health insurance companies can utilize the TCC method to improve the level of care they provide to their ED patients. For example, managed care insurance companies are now scrutinized and measured by the government to improve the medical status of the diabetes patient group. There is an actual score given to companies which is used to measure the managed care company's compliance in controlling diabetes. By using the TCC, the managed care companies can improve their scores for various specific medical conditions. The method would involve mailing ED patients on the managed care database a letter from the managed care company. The letter instructs the patient to call TCC. When the patient calls they are assessed, educated and have appointments made to go to further education and to see a physician.

Pharmacy companies can use TCC to promote sales. An example of a pharmacy program would be very similar to the above managed care program. The pharmacy wants patients to move to new medications or to get on medications for profit reasons. TCC would mail ED patients that are indicated on the pharmacy database and process them in the same way we would handle the managed care lists. This helps the government achieve the goal of a healthier ED population, which significantly holds down health care costs.

Government agencies such as the Center for Disease Control can help hold down health care costs by providing grants to create broad awareness of the TCC, to reach out to people who do not have insurance or have never gone to the doctor for treatment of their special medical condition. For example, such people could be brought to TCC by advertising how to keep a healthy sex life. This would get them into education programs to keep their whole body well.

Health systems which have doctors who specialize in a specific medical condition will provide grants so the TCC will funnel high volumes of patients with specific medical conditions into a specific pathway. This pathway would have only the staff and facilities needed for this type of care. The result is a highly cost effective system for a specific medical condition.

The entities described above that are involved in cooperative funding and become subscribers to the TCC wellness program are considered to be contributors in TCC in the sense that they pay fees which support the operation of the TCC. As used herein, the term “contributor” means an entity that is a subscriber to the TCC wellness pathway.

Costs of Operating TCC

TCC incurs costs of operation of the same type and in a similar manner as a conventional service company. In addition to general overhead costs, TCC has operating costs of various kinds one of which is advertising which constitutes a major cost of TCC. Special costs pertaining to operation are described below.

TCC also has an arrangement for affinity grant funding to promote the use of the wellness path. Affinity grant funding is provided by an arrangement of TCC with certain entities which also have a relationship with the patients in the wellness pathway. In particular, such entities are typically not-for-profit associations such as US TOO, International and American Diabetes Association. Such arrangements typically provide for giving grant money by TCC to such entities out of the cooperative funding described above. These grants are given based on number of inquiries made by via telephone or otherwise to the TCC by prospective patients who learned of TCC through the association. The TCC tracks such inquiries using its affinity grant computer software system and thereby relates the amount of the grant to the number of inquiries credited to each entity. Examples of arrangements with participants in the affinity program are set forth in the attached Exhibits B, C and D.

TCC, as mentioned above, is a not-for-profit company and is licensed to use the proprietary methodology set forth in this patent application and any other intellectual property rights needed for operation of TCC. License fees will be paid by TCC to the owner of such rights.

Operation of TCC Wellness Pathway

In order to reach prospective patients, the facilitator company, i.e. TCC advertises its services via all forms of direct-to-consumer advertising including print, broadcast and internet media. TCC will subcontract the execution of the above services to the appropriate vendor. The advertisement invites inquiries (by the toll free telephone number of TeleCareCenter or otherwise) from interested persons.

TCC, as described above, has facilities which are used by its patient advocates to receive inquiries via telephone (and other media) from prospective patients seeking information regarding the medical condition ED. The patient advocate is a medical professional such as a nurse trained in that particular condition. The patient advocate's services are provided free of charge to any caller and is available to the caller for either brief or protracted discussions of ED without requiring identification of the person. The mission of the patient advocate at this early stage is to answer questions and also to gain the confidence of the caller so that the caller will feel free to reveal information needed by the patient advocate to help the caller reach a decision on whether to enter the wellness pathway of TCC. If appropriate, the caller is invited to call back with any further questions and several conversations may take place before the caller decides see a doctor and thus becomes a prospective patient. Such a decision may ensue after the patient advocate has provided sufficient education regarding the caller's condition and the approved therapies. The patient advocate provides a choice of doctors that specialize in ED and are located so as to be reasonably available to the prospective patient. The patient advocate makes an appointment with the chosen doctor suitably while the patient is on the phone, and may follow-up with a reminder to the prospective patient to attend the appointment as well as a follow-up to determine whether the appointment was completed. The patient advocate may determine from the doctor's office whether a future appointment has been made by the prospective patient and providing a reminder to the patient. This procedure may be repeated by the patient advocate until the doctor reports that no further appointments need to be scheduled. The wellness condition of the patient is determined after each appointment from the patient and such information is recorded in the file of the TCC. The computer system of TCC including its specialized patient tracking software is used by the patient advocate to record information about each contact with the patient and with the doctor so that a tracking record is created from the time of the first inquiry to the final discharge of the patient from the wellness path.

The treatment of the prospective patient from the point of entry and the point of exit from the wellness pathway is set forth in the following example:

Jim is 65 years old and had his prostate cancer surgery about 9 months ago. The operation was successful but it has left him impotent. In Jim's search for answers he joins US TOO (an international prostate cancer survivor organization with over 500 chapters in the U.S.) One evening he decides to go onto their website to see if they have any information about his Erectile Dysfunction commonly know as ED.

He finds information about ED and a referral to a place called the TeleCareCenter^{SM} where he can call toll free to be educated about his ED and what he can do to return to a normal sex life. There is also a TeleCareCenters^{SM} website he can go to for educational write-ups on ED and prostate cancer.

Jim checks out the website and decides to call their 800 number. He winds up talking to nurse called Bonnie. She is so easy to talk to and knows what Jim is going through. They talk about his cancer and how the surgery caused his ED. It's not his fault. They then go into a lengthy discussion about the various treatments and typically which ones to start with. Jim shares he has tried Viagra but it is not effective enough to have intercourse. Jim's wife Mary has a few questions and she gets on the phone with Bonnie and they chat for while. Mary feels more comfortable, they have now found a new medical pathway that provides them medical professionals who:

They can “Talk to”;

Will advocate for them;

Educate them on a specific condition;

Provide a choice of doctors who specialize in this condition; and

Schedule an appointment with the doctor they choose.

Jim shares that it is hard to have a conversation with his urologist but gets along well with the nurse in the office. Bonnie suggest that Jim go back to the doctor's nurse and talk about getting a vacuum pump device and try this with the Viagra to see if that will work. Bonnie then schedules a follow up call with Jim and puts that in her TeleCareCenter^{SM} computer system for follow up.

About three weeks go by and the system reminds Bonnie to call Jim. Bonnie pulls his file and refreshes herself with his condition. Jim tells her the Viagra and Pump solution is not working well; he is very uncomfortable with it.

At this point Bonnie realizes that to get Jim taken care of he will have to see a urologist that specializes in treating ED. She goes to her TeleCareCenter^{SM} database system to lookup urologists who specialize in ED in Jim's neighborhood and gives Jim a choice of these doctors in his area, and Jim selects Dr. Smith. While Jim is still on the phone Bonnie schedules the appointment for him. (She has appointment slots in her computer and can book the appointment while Jim is talking to her.)

Jim now begins his continuing journey through the wellness path of the TeleCareCenter^{SM} for getting his ED fixed.

Two days before Jim's appointment Bonnie's computer reminds her to call to make sure Jim is going or if he needs to reschedule. Jim's OK and Bonnie tells him she will call him after the appointment to see how things went. All this follow-up is controlled by the TeleCareCenter^{SM} computer system.

Three days after the appointment Bonnie calls Jim to see if went or if something came up and they have to reschedule. Jim is really pleased. He is now taking shots and all is working well He knows that as he ages the shots may not work as well or he may not like to continue the injections. But he knows that implants and some other therapies are available and he has the TeleCareCenter^{SM} as his new pathway to educating him and helping him find doctors who can work with him to have a healthy sex life with his wife of 35 years.

The system and methodology of the facilitator, e.g. the TeleCareCenter , as described above, operates to move a patient having ED through the TCC wellness pathway.

The method of this invention for use with any specific medical condition as practiced by a facilitator, e.g. TCC, is represented in the flow chart 10 in the attached one sheet drawing. The first step 12 of the method comprises the selection of the specific medical condition to be treated in the wellness pathway and the identification of the general class of patients to be targeted. In method step 14 an advisory council is established for the selected conditions. The advisory council will consist of several persons who are well qualified regarding the treatment of patients for the selected medical condition and the medical drugs and devices for such treatment and persons qualified in the ethics of medical practice. In method step 16, the facilitator's plan for the wellness pathway is presented to prospective contributors to cooperative funding and prospective participants in affinity grant funding. Method step 18 is a generation of customer awareness through advertising. This is designed to attract inquiries from prospective patients having the specific medical condition. Method step 20 performs the education function in response to calls from prospective patients. Method step 22 provides the appointment scheduling with the doctor chosen by the prospective patient. Method step 24 is the performance by the patient advocate in managing the doctor appointment process from beginning to end. It is noted that each of the method steps 18, 20, 22 and 24 is correlated with and supplies information to the method step 30 which generates doctor appointments information and data base. Method step 26 is linked with method steps 24 and 30 and whereby its usage tracking of medical drugs and devices and tracking of doctor services. Method step 28 is linked with both method steps 26 and 30 and functions to provide performance reports to contributors. The method represented by flow chart 10 is facilitated by the use of the computer system under control of patient tracking software and contributor tracking software. This includes data bases and report generating capabilities for the performance of the steps 18 through 30.

Supplemental Disclosure

The TCC methodology and apparatus moves patients with certain conditions (e.g. Erectile dysfunction) to a portal (i.e. TCC) where they select a pathway, which can satisfy their condition. Specifically trained patient advocates (i.e. nurses) guide them through their conditions pathway providing education on their condition; known causes; professionally recognized methods/products/services; and a choice of experts (doctors). In addition to education, the advocate offers and schedules an appointment with their choice of expert; and be there as someone to talk to as they are being cared for by the expert.

Product and service providers for specific medical conditions are looking for ways to increase in “market size”. This appointment-generating method of TCC gives these providers who share a “common end customer” (patient) a new way to profitably contribute to reaching this goal. These providers become contributors and thus in the cost of operating TCC and join with one another (doctors, drug and equipment manufacturers, health care systems, etc.) in ways that avoid infringing on laws and ethical practices, while providing added value to the patient. Each contributor pays fees for usage of TCC. In return, TCC generates for each contributor: potential customers, measures response rates and financial performance; by source of name and type of direct advertising; for each step in the pathway, and the entire journey.

TCC uses all forms of direct advertising (internet, direct response print/TV/radio/etc.) to generate potential patients and harvest those provided by various contributors. All marketing, advertising and sales support activities are statistically recorded, measured and controlled with a unique software system that tracks customers from awareness of a portal through each step along their chosen pathway. The system schedules call backs and generates mailings using the database to encourage an appointment; keeps track of appointments; issues confirmation; reminds prospects of their appointment; reschedules appointments; tracks how the appointment went; tracks and measures usage of each contributor's product/service. An advisory council of industry leaders helps oversee the advocacy guidelines for operating the machine to ensure credibility and quality along each pathway.

### CONCLUSION

In view of the foregoing disclosure, it will be appreciated that the invention is useful in a wide variety of applications especially in the health care industry and that it may be implemented in a wide variety of embodiments.

What is claimed is:

1. A method of doing business comprising the steps of:
establishing a facilitator company having business purposes of generating health care awareness, providing health care education and providing a health care access system, said facilitator company having management personnel and personnel who are patient advocates for prospective patients, said facilitator company also having communications facilities that provide communication with patients, doctors, health systems, manages care insurance companies and pharmacy companies, said facilities including a telephone system and a computer system with access to the internet and having a website on the internet, whereby the facilitator company can establish a wellness pathway (healthcare) which is available to the public in a nationwide health care system,
said facilitator company performing the steps of:
a) advertising its services via at least one media including print, broadcast and internet media,
b) contracting with plural medical doctors who specialize in treating a specific medical condition whereby said doctors become subscribers to the facilitator's wellness pathway and agree to,
(i) accept at least one appointment with a specified prospective patient, said appointment being made and coordinated by a patient advocate from the facilitator company,
(ii) pay a fee to the facilitator company,
(c) contracting with plural suppliers of medical drugs and medical devices whereby said suppliers become subscribers to the facilitator's wellness pathway and agree to
(i) make their products available to doctors who are subscribers to said wellness pathway,
(ii) report the name of each doctor who has used its products and other specified information, and
(iii) pay a fee to the facilitator company for using the wellness pathway,
(d) having a patient advocate answer telephone calls from prospective patients, and furnish information and services at no charge, as follows:
provide education on the causes of known medical conditions and approved therapies, provide a choice of doctors that specialize in a specific condition, said doctors being located in the vicinity of the prospective patient, make an appointment with the chosen doctor, remind the prospective patient to attend the appointment and follow up to determine whether the appointment was completed,
(e) determining from the chosen doctor's office whether a future appointment has been made by the prospective patient,
(f) determining a wellness condition of the patient after step (e) from the patient and recording the same in the records of the facilitator company,
whereby the patient is guided through the wellness pathway and receives the benefit of expedited treatment by a doctor who specializes in the patient's specific condition, said doctor has available different choices of medicines, drugs, prosthetics and other therapies from different manufacturers for treatment of the patient, and whereby the doctors, suppliers and any other investor can be more effective by increased efficiency of operations and increased numbers of patients and whereby the facilitator company can be financially self-sustaining in the operation and management of the wellness pathway.
